(19) United States
(12) Patent Application Publication
(10) Pub. No.: US 2021/0214205 A1
(43) Pub. Date: Jul. 15, 2021

(54) FORKLIFT SAFETY SYSTEM

(71) Applicant: Brooks STRONG, Houston, TX (US)

(72) Inventor: Brooks STRONG, Houston, TX (US)

(21) Appl. No.: 17/146,245

(22) Filed: Jan. 11, 2021

Related U.S. Application Data
(60) Provisional application No. 62/959,704, filed on Jan. 10, 2020.

(51) Int. Cl. B66F 17/00; B66F 9/24

(52) U.S. Cl. CPC B66F 17/003; B66F 9/24

(57) ABSTRACT

A machinery safety system can include a lift machine having a lifting apparatus with the lifting apparatus operable to receive a load thereon and translatable at least a predetermined distance. A control module can be operably coupled with at least one sensor with the at least one sensor comprising at least one lift sensor operably coupled with at least a portion of the lifting apparatus. A feedback indicator can be operably coupled with the control module, wherein the feedback indicator is operably to display one or more outputs from the control module based on data received from the at least one lift sensor.

### CROSS REFERENCE TO RELATED APPLICATIONS

The present application is claims the benefit of U.S. Provisional Application No. 62/959,704, filed Jan. 10, 2020, the contents of which are incorporated herein in their entirety.

### FIELD

The present disclosure relates generally to machinery safety systems, more particularly to forklift safety systems.

### BACKGROUND

Lift trucks and/or related machinery are often implemented to move large quantities of products within an environment (e.g. warehouse, equipment yard, etc.). The lift trucks can be implemented to place products in elevated storage positions, as well as move them from point to point within the environment.

Movement of these products, including in elevated positions, can be complicated by unknown weight, uneven weight distribution, and/or unknown lifting parameters.

### BRIEF DESCRIPTION OF THE DRAWINGS

Further features of the present disclosure will become apparent to those skilled in the art to which the present disclosure relates from reading the following specification with reference to the accompanying drawings, in which:

FIG. 1 is a diagrammatic view of a forklift safety system, according to at least one instance of the present disclosure;

FIG. 2 is a diagrammatic view of a forklift having a safety system received thereon, according to at least one instance of the present disclosure;

FIG. 3 is a diagrammatic view of forklift forks having safety system sensor received thereon, according to at least one instance of the present disclosure; and

FIG. 4 is a diagrammatic view of a remote management forklift safety system, according to at least one instance of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The term “lift truck” and/or “fork lift” refers to any commercial and/or industrial machinery operable to translate a load (e.g. mass) at least a portion of a predetermined height including but not limited to a lift truck, reach truck, forklift, pallet jack, or the like.

The term “axle” refers to any load supporting element of a lift truck and/or fork lift including a solid axle, an independent suspension, a fixed roller wheel (e.g. castor, etc.), track system, and/or any other lift truck supporting element or combinations thereof.

While the present disclosure is drawn to a safety system implemented with a forklift, it is within the scope of this disclosure to implement the safety system with machinery operable to move loads from point to point including any warehouse machinery.

The presently disclosed safety system includes one or more sensors disposed on one or more forks, axles, masts, hydraulic support plates, and/or any combination thereof operably coupled to a control module. The control module can receive inputs from the one or more sensors to determine mass, distribution, center of gravity, and/or rollover risk. In at least one instance of the present disclosure, the safety system can have a sensor disposed on each lifting member operable to determine the mass, weight distribution, and/or center gravity of the load thereon. The safety system can have one or more sensor disposed on an axle, mast, and/or hydraulic support plate.

The safety system can include a pallet sensing system operable to provide a user real-time feedback regarding engagement between one or more lifting member and/or a load. In at least one instance, the safety system can be operable to determine an attempted de-loading effort by the operator, but still having at least tangential engagement between at least one lifting member and the load, thereby providing a feedback indicator to the operation that the load (e.g. pallet, etc.) is still engaged with at least one lifting member.

The system described herein can include wired and/or wireless communications between any combination of the one or more sensors, the one or more axles, the one or more lift sensors, a control module, and/or a feedback indicator.

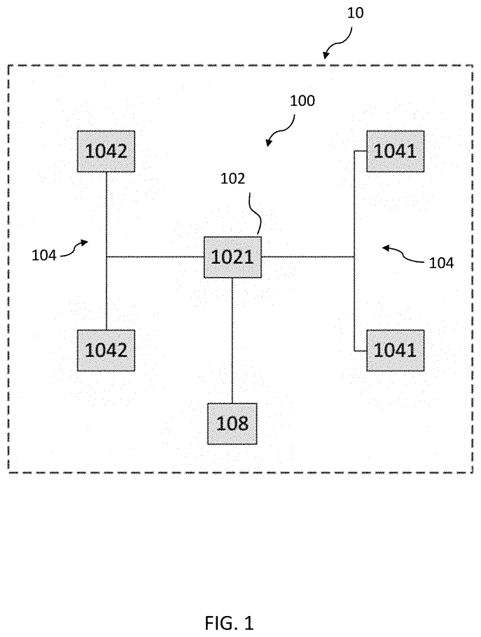

FIG. 1 illustrates a lift machine safety system according to at least one instance of the present disclosure. The safety system 100 can be operable installed on a lift machine 10 operable to assist in transportation of goods from point to point. The lift machine 10 can be operable transport, lift, and/or otherwise move goods within an environment. While the lift machine 10 is described and shown as a forklift, it is within the scope of this disclosure to implement the safety system with any operational machinery including, but not limited to, reach trucks, pallet jacks, boom lifts, and the like.

The safety system 100 can have a control module 102 and a plurality of sensors 104 coupled therewith. The plurality of sensors 104 can include two lift sensors 1041 and two axle sensors 1042 coupled with the control module 102, respectively. The lift sensors 1041 can be coupled with one or more lifting elements of the lift machine 10 and operable to determine the load and/or distribution of the load across the one or more lifting elements. The lift sensors 1041 can be operable coupled with the control module 102 to communicate the load and/or distribution of the load to the safety system 100. In at least one instance, the lift sensors 1041 can be a strain gauge.

The lift sensors 1041 and/or the control module 102 can be collectively coupled to allow accurate determination of a load mass, and distribution of a load front or back (e.g. longitudinal direction) and/or left to right (e.g. lateral direction). In at least one instance, a lift machine 10 can be a fork lift having a pair of forks each having two longitudinally displaced lift sensors 1041. Collectively, the four load sensors 1041 can determine the mass of a load received on the pair of forks of the lift machine 10. In some instances, the longitudinally displaced lift sensors 1041 can operably determine the distribution of the load front to back, while sensors disposed on opposing forks can operably determine the distribution of the load left to right. The control module 102 can operably receive data from each of the plurality of lift sensors 1041 to determine the load and/or load distribution of the load across the lift machine 10.

The safety system 100 can further integrate axle sensors 1042 operable to determine the center of gravity and/or balance of the lift machine 10 with and/or without a load. The axle sensors 1042 adjacent to each wheel of an axle of the lift machine 10. In an instance of a double axle lift machine 10, the safety system 100 can implement four axle sensors 1042, two per axle. The control module 102 operable coupled with the plurality of axle sensors 1042 to determine the center of gravity of the lift machine with and/or without the load and/or the angle of inclination of the lift machine 10 in a later and/or longitudinal orientation.

The safety system 100 can further be coupled with the status of the lift machine 10 allowing the control module 102 to receive positional feedback, including but not limited to, Global Positioning System (GPS) information, lift machine 10 mast angle, and/or g-force data from an accelerometer, and the like, from the lift machine 10. In at least one instance, the control module 102 can be operable to receive information from the lift machine 10 representative of one or more features of the lift machine including, but not limited to, the height of the lifting apparatus (e.g. forks), travel speed, and the like.

The control module 102 can include a processor 1021 operable to receive data from the one or more sensors 104 within the safety system 100. The processor 1021 can be operable to determine load mass, load distribution, center of gravity of the load, center of gravity of the lift machine 10, and/or other measurements based on the measured strain from the one or more sensors 104. The processor 1021 can be a local processor operable to be wirelessly coupled with the one or more sensors of the safety system 100.

The processor 1021 can be operable to receive data from one or more sensors of the safety system 100 and send a signal to a feedback indicator regarding the data from the one or more sensors. In at least one instance, the control module 102 and/or the processor 1021 can receive data from the one or more lift sensors 1041 indicating of a weight of a load on the lift machine 10, and send a signal to a feedback indicator 108.

The control module 102 can output a signal to the feedback indicator 108 operable to provide an operator one or more measurements, elements, and/or alerts about the operation of the lift machine 10. The feedback indicator 108 can be operable to provide an operator with an auditory, visual, vibratory, and/or interactive notification regarding one or more measurements, elements and/or alerts of the lift machine. The feedback indicator 108 can include, but is not limited to, lights, sirens, vibratory elements, speakers, displays, and the like. In at least one instance, the feedback indicator 108 can be a touch screen operable to display a load measurement, a center of gravity display, and/or provide alerts if a predetermined threshold of load management is achieved.

While FIG. 1 is generally described as having two lift sensors 1041 and/or two axle sensors 1042, it is within the scope of this disclosure to implement the safety system 100 with any number of lift sensors 1041, axle sensors 1042, and/or any combination thereof including, but not limited to, one lift sensor 1041, one axle sensor 1042 and/or omitting lift sensors 1041 or axle sensors 1042 from the safety system 100 depending on a particular application.

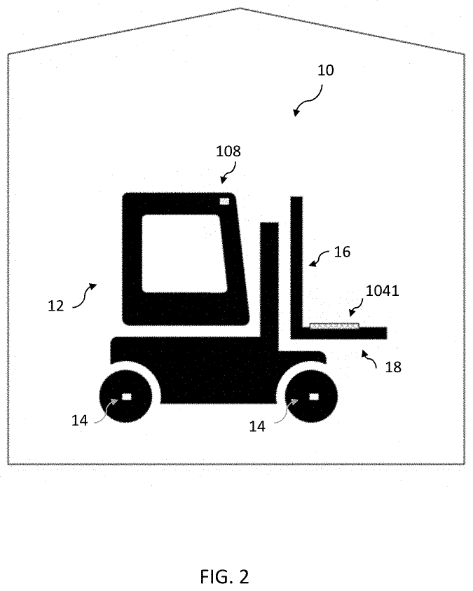

FIG. 2 illustrates a lift machine having a safety system installed thereon. The lift machine 10 can include a body 12, axle 14, and a lifting apparatus 16. The safety system 100 can integrate with the lift machine 10, the body 12, the axle 14, and/or the lifting apparatus 16 to provide feedback regarding operation of the lift machine 10.

As can be appreciated in FIG. 2, the lift machine 10 can have a safety system 100 installed thereon including at least one lift sensor 1041 on each fork 18 of the lifting apparatus 16 and at least one axle sensor 1042 on the each axle 14. The safety system 100 can receive input from the lift sensors 1041 on each fork to determine the mass of the load, and its center of gravity individually and/or how the load alters the center of gravity of the lift machine 10. While FIGS. 1 and 2 are illustrates with respect to a specific instance of the present disclosure implementing an axle sensor 1042 on each axle 14 of the lift machine, it is within the scope of this disclosure to implement the safety system 100 with any number of axle sensors 1042, including in at least one instance the omission of axle sensors 1042, or one or more axle sensors 1042 on only one axle of the lift machine 10, respectively.

The safety system 100 can determine the center of gravity of the load using the lift sensors 1041 and/or the center of gravity of the lift machine 10 using the lift sensors 1041 and/or the axle sensors 1042. The center of gravity of the lift machine 10 can be determined in real-time, specifically as the height of the load is adjusted using the lifting apparatus 16 thereby altering the center of gravity of the lift machine 10.

In at least one instance, the safety system 100 can assist in prevention of tip over accidents of the lift machine 10 by processing, via the control module 102, data from the lift sensors 1041 and/or axle sensors 1042. The safety system 100 can provide alerts to prevent an operator from raising a load over a predetermined height based on the altered center of gravity, travel speed, tilt orientation, and/or travel direction. The safety system 100 can provide alerts and/or feedback to an operator at a user-programmable height and/or based on load to height ratio. The safety system 100 can receive data regarding the mass of a load on the lift machine 10, and dynamically adjust the predetermined height at which an alert is generated based on the detected mass.

In at least one instance, the load to height ratio, the predetermined height, and/or the max load can be user-programmable features depending on the lift machine 10 and/or the specific application. The user-programmable features can be determined by the location (ceiling height, etc.), lift machine capabilities, user preference, shelving capacity, and/or the like.

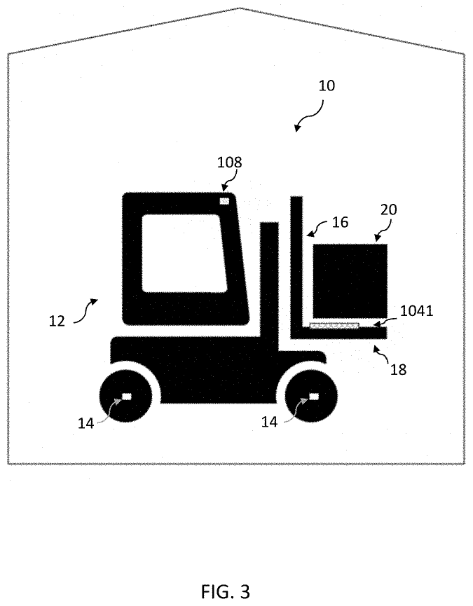

In other instances, the safety system 100 can provide alerts to an operator of the lift machine upon the control module 102 receiving data indicative of uneven load distribution upon the forks 18 (described in more detail with respect to FIG. 3), and/or exceeding of a max load rating of the lift machine. In yet other instances, the safety system 100 can override and/or control the lift machine to prevent an operator from exceeding one or more predetermined thresholds including, but not limited to, height, weight, height/weight ratio, max load, speed, uneven load distribution, and/or combinations thereof.

FIG. 3 illustrates a forklift having a safety system installed thereon having an uneven load distribution across two forks of the forklift. The lift machine 10 can have a pallet and/or other load 20 disposed on the forks 18. The safety system 100 can provide real-time feedback regarding load distribution between the forks 18 and/or insufficient contact of between the load 20 and one fork 18.

In some instances, upon receiving the forks 18 under a pallet load 20 one fork 18 may not appropriately contact the load, thus balancing the load on a single fork 18 and/or unevenly loading upon the forks 18. The lift sensors 1041 can provide feedback to control module 102 regarding load distribution between the forks 18, allowing feedback to an operator that the load may not be contacting a fork 18 requiring removal and reinsertion of the forks under the pallet load 20 and/or readjustment of the forks 18.

In other instances, during movement of the lift machine 10 the safety system 100 can provide operation feedback should travel speed and/or travel direction of the lift machine 10 change the load registered by one or more sensor 104 beyond a predetermined threshold. The travel speed and/or travel direction can lead to the potential tipping/leaning of the lift machine and/or the pallet load 20.

The safety system 100 can provide real-time, instantaneous feedback to an operator upon passing a predetermined threshold of uneven distribution of pallet load 20 and/or uneven weigh distribution of the lift machine 10 on the axles 14. In at least one instance, the feedback can be instantaneous when the predetermined threshold is exceeded for at least a predetermined period of time.

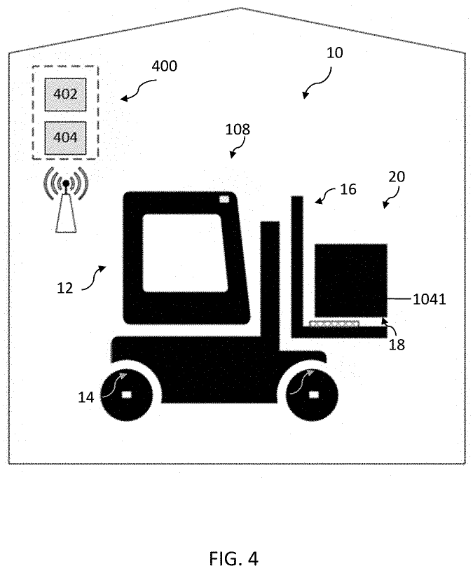

FIG. 4 illustrates a diagrammatic view of a remote management forklift safety system, according to at least one instance of the present disclosure. The forklift safety system 100 can wirelessly couple with a remote management unit 400 operable to data log information from the one or more sensors 104 from the lift machine 10. The remote management unit 400 can include one or more processors 402 and storage members 404 (including, but not limited to, hard disk drives (HDD) and/or flash memory) operable to receive and/or store data received from the forklift safety system 100.

The remote management unit 400 can be operably coupled with the forklift safety system 100 of one or more lift machines 10, thereby allowing operational management of any number of lift machines 10. The remote management unit 400 can store data received from each of the one or more forklift safety systems 100 including data logging regarding alerts generated by each of the forklift safety systems 100. The remote management unit 400 can further track lift machine usage including total mass, height, run time, and/or combinations thereof to assist in providing maintenance feedback based on cyclic loading and/or thresholds of lifting, height, and/or mass.

In at least one instance, the remote management unit 400 can log, track, and/or generate reports with respect to the alerts generated by one or more forklift safety systems 100 over a predetermined period of times, including operated specific reports, thereby allowing operational management of a fleet and/or a particular operator. In at least one instance, the forklift safety system 100 can require authentication of an operator prior to operation of the lift machine 10, and the remote management unit 400 can log all operational data with respect to the individual operator.

The remote management unit 400 can be a local server, a remote server, and/or a cloud-based storage solution allowing worldwide monitoring operation of lift machines 10. The remote management unit 400 can further allow two-way communication with the forklift safety system 100 to provide updates to the forklift safety system 100, update user defined operational alert thresholds, and/or provide operator-specific alerts or reminders.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims.

What is claimed is:

1. A machinery safety system comprising:
a lift machine having a lifting apparatus, the lifting apparatus operable to receive a load thereon and translatable at least a predetermined distance;
a control module operably coupled with at least one sensor, the at least one sensor comprising at least one lift sensor operably coupled with at least a portion of the lifting apparatus;
a feedback indicator operably coupled with the control module;
wherein the feedback indicator is operably to display one or more outputs from the control module based on data received from the at least one lift sensor.

2. The machine safety system of claim 1, wherein the lifting apparatus is a two forks operably coupled with a lift machine, the at least one lift sensor being at least one lift sensor operably coupled with each fork of the two forks.

3. The machine safety system of claim 2, wherein control module can operably determine a load distribution between the two forks via the at least one lift sensor operably coupled with each of the two forks.

4. The machine safety system of claim 3, wherein the control module generates at least one output when the load distribution exceeds a predetermined threshold.

5. The machine safety system of claim 4, wherein the predetermined threshold is adjustable by an operator.

6. The machine safety system of claim 1, wherein the control module receives one or more input from the at least one sensor and generates the one or more outputs to the feedback indicator in view of the one or more inputs.

7. The machine safety system of claim 6, wherein the one or inputs include the predetermined distance of the lifting apparatus, and a mass of the load received thereon.

8. The machine safety system of claim 1, wherein the at least one sensor further comprises at least one axle sensor operably coupled with an axle of the lift machine.

9. The machine safety system of claim 8, wherein the at least one axle sensor is operably coupled with the control module and/or the feedback indicator.

10. The machine safety system of claim 1, wherein the one or more output is generated by the load exceeding a predetermined portion of the predetermined distance.

11. The machine safety system of claim 10, wherein the predetermined portion of the predetermined distance is adjustable by an operator.

12. The machine safety system of claim 1, wherein the one or more outputs is generated by the load exceeding a predetermined mass

13. The machine safety system of claim 12, wherein the predetermined mass is adjustable by an operator.

14. The machine safety system of claim 1, wherein the one or more outputs include a load distribution in a lateral direction and/or a longitudinal direction.

15. The machine safety system of claim 14, wherein the lateral direction extends across the lift apparatus, and wherein the lift apparatus extends away from the lift machine a predetermined distance along the longitudinal direction.

16. A machinery safety system comprising:
a lift machine having a lifting apparatus, the lifting apparatus operable to receive a load on at least a portion thereof, the lifting apparatus translatable at least a predetermined distance in at least one predetermined direction;
a control module operably coupled with at least one load sensor, wherein the at least one load sensor is operably disposed the portion of the lifting apparatus;
a feedback indicator operably coupled with the control module;
wherein the feedback indicator is operably to display one or more outputs from the control module based on data received from the at least one lift sensor;
wherein the one or more outputs include a load distribution in a lateral direction and/or a longitudinal direction.

17. The machinery safety system of claim 16, wherein the lifting apparatus extends a predetermined length from the lift machine, the load distribution in the longitudinal direction corresponding to along the predetermined length.

18. The machine safety system of claim 16, wherein the lifting apparatus includes two substantially parallel lift forks, each lift fork having one or more load sensor disposed thereon, and the load distribution between the two lift ports corresponding to the load distribution in the lateral direction.

19. The machine safety system of claim 16, wherein the feedback indicator generates one or more alerts if the load distribution in the lateral direction exceeds a predetermined threshold.

20. The machine safety system of claim 16, wherein the feedback indicator generates one or more alerts if the load distribution in the longitudinal direction exceeds a predetermined threshold.
